(19) United States
(12) Patent Application Publication
(10) Pub. No.: US 2026/0097776 A1
(43) Pub. Date: Apr. 9, 2026

(54) APPARATUS AND METHOD OF DIAGNOSING A CAUSE OF INCREASED EXHAUST GAS USING AN AUTOENCODER, AND A VEHICLE INCLUDING THE SAME

(71) Applicants: HYUNDAI MOTOR COMPANY, Seoul (KR); KIA CORPORATION, Seoul (KR)

(72) Inventor: Jin Gwon Park, Hwaseong-si (KR)

(73) Assignees: HYUNDAI MOTOR COMPANY, Seoul (KR); KIA CORPORATION, Seoul (KR)

(21) Appl. No.: 19/175,547

(22) Filed: Apr. 10, 2025

(30) Foreign Application Priority Data
Oct. 4, 2024 (KR) 10-2024-0134634

(51) Int. Cl. B60W 50/02; G06N 3/0455

(52) U.S. Cl. CPC B60W 50/0205; G06N 3/0455; B60W 2050/021

(57) ABSTRACT

An apparatus for diagnosing a cause of an increase in exhaust gas using an autoencoder includes: at least one processor; and a storage medium for storing a computer-readable instruction, wherein when the computer-readable instruction is executed by the at least one processor, the computer-readable instruction is configured to cause the processor to: receive input data, wherein the input data includes at least two or more factors including a sensed value; determine a reconstruction error for each of the at least two or more factors, wherein the reconstruction error is a reconstruction error between the input data and restored data obtained by inputting the input data to a pre-learned autoencoder; and diagnose the cause of the increase in exhaust gas, based on the reconstruction errors.

### CROSS-REFERENCE TO RELATED APPLICATION(S)

This application claims the benefit of and priority to Korean Patent Application No. 10-2024-0134634 filed on Oct. 4, 2024 in the Korean Intellectual Property Office, the disclosure of which is incorporated herein by reference in its entirety.

### BACKGROUND

### Technical Field

The present disclosure relates to an apparatus, method, and vehicle for diagnosing a cause of an increase in exhaust gas using an autoencoder.

### Description of Related Art

The EURO7 standards introduced in Europe require a new concept of exhaust gas monitoring called on-board monitoring (OBM). According to OBM, when a concentration of nitrogen oxide (NOx) is measured and exceeds emission limits, a warning light may be turned on.

However, in this case, since the warning light is only turned on based on exhaust gas, it is impossible to accurately confirm which component or system is a cause of an increase in exhaust gas. Therefore, in cases in which the warning light is turned on based on the exhaust gas, it is necessary to inform a driver of the cause of the increase in exhaust gas.

### SUMMARY

An aspect of the present disclosure is to provide an apparatus, a method, and a vehicle for diagnosing a cause of an increase in exhaust gas using an autoencoder, which may confirm whether the cause of the increase in exhaust gas during exhaust gas monitoring is due to a component or a system.

According to an aspect of the present disclosure, an apparatus for diagnosing a cause of an increase in exhaust gas using an autoencoder includes at least one processor and a storage medium storing a computer-readable instruction. When the computer-readable instruction is executed by the at least one processor, the computer-readable instruction is configured to cause the processor to: receive input data, wherein the input data includes at least two or more factors including a sensed value; determine a reconstruction error for each of the at least two or more factors, wherein the reconstruction error is a reconstruction error between the input data and restored data obtained by inputting the input data to a pre-learned autoencoder; and diagnose the cause of the increase in exhaust gas, based on each of the reconstruction errors.

According to an embodiment of the present disclosure, the at least one processor may be configured to accumulate and average the reconstruction errors (which results in an accumulated and averaged reconstruction error).

According to an embodiment of the present disclosure, the at least one processor may be configured to determine an error rate for each of the at least two or more factors, wherein the error rate is a value obtained by dividing the accumulated and averaged reconstruction error by a preset reference value. The at least one processor may also be configured to diagnose the cause of the increase in exhaust gas, based on each of the error rates.

According to an embodiment of the present disclosure, the preset reference value may be an average value of the reconstruction errors obtained in a normal driving state in which the exhaust gas is lower than or equal to a preset value for each of the at least two or more factors.

According to an embodiment of the present disclosure, the at least one processor may be configured to determine whether a measured nitrogen oxide (NOx) concentration value exceeds a preset value and diagnose the cause of the increase in exhaust gas, when the measured NOx concentration value exceeds the preset value, or when the measured NOx concentration value exceeds the preset value and a warning light is turned on.

According to an embodiment of the present disclosure, the at least one processor may be configured to determine whether a stable driving condition is satisfied, and wherein the stable driving condition includes one or more of a vehicle speed, an engine revolutions per minute (RPM), a state in which a reverse gear is not engaged, an engine gas recirculation (EGR) ratio, a state in which a lambda control factor is not 1, a state in which learning of an on-board diagnostics (OBD) item is completed, an atmospheric pressure, or a state in which a driving mode of a vehicle is not a sports mode.

According to an embodiment of the present disclosure, the factors may include one or more of a fuel pressure, a rear lambda voltage, a lambda control factor, a variable valve timing (VVT) incam error, a variable valve timing (VVT) excam error, a long term fuel trim (LTFT), an engine roughness sum, an engine gas recirculation (EGR) flow error, or a variable geometry turbocharger (VGT) value error.

According to an embodiment of the present disclosure, the at least one processor may be configured to diagnose, as the cause of the increase in exhaust gas, a fuel system when an error rate of the fuel pressure is greater than a preset error rate, a rear oxygen sensor when an error rate of the rear lambda voltage is greater than the preset error rate, a front oxygen sensor when an error rate of the lambda control factor is greater than the preset error rate, an intake VVT when an error rate of the VVT incam error is greater than the preset error rate, an exhaust VVT when an error rate of the VVT excam error is greater than the preset error rate, an air-fuel ratio when an error rate of the long term fuel trim is greater than the preset error rate, a misfire when an error rate of the engine roughness sum is greater than the preset error rate, an EGR when an error rate of the EGR flow error is greater than the preset error rate, and a VGT when an error rate of the VGT valve error is greater than the preset error rate.

According to an embodiment of the present disclosure, when the air-fuel ratio is diagnosed as the cause of the increase in exhaust gas, the at least one processor may be further configured to diagnose the air-fuel ratio as a lean state when the air-fuel ratio is greater than 1, or to diagnose the air-fuel ratio as a rich state when the air-fuel ratio is less than 1.

According to an embodiment of the present disclosure, the input data may further include engine status data, and wherein the engine status data may include a map sensor signal, an injection time, an engine revolution per minute (RPM) value, an engine load, a vehicle speed, a VVT incam angle, a VVT excam angle, a lambda controller output, a front lambda voltage, a lambda set value, or a controller value.

According to an embodiment of the present disclosure, the at least one processor may be configured to output the cause of the increase in exhaust gas.

According to an embodiment of the present disclosure, the at least one processor may be configured to output a cause of an increase related to a factor in magnitude order of an error rate, for each of the at least two or more factors, or output a cause of an increase related to a factor of a preset number of which a magnitude of an error rate is large (i.e., satisfies a predetermined threshold), among the at least two or more factors, in magnitude order of an error rate.

According to an aspect of the present disclosure, a method for diagnosing a cause of an increase in exhaust gas using an autoencoder, includes: receiving input data, wherein the input data includes at least two or more factors including a sensed value; determining a reconstruction error for each of the at least two or more factors, wherein the reconstruction error is a reconstruction error between the input data and restored data obtained by inputting the input data to a pre-learned autoencoder; and diagnosing the cause of the increase in exhaust gas, based on each of the reconstruction errors.

According to an embodiment of the present disclosure, the method may further include an operation of accumulating and averaging each of the reconstruction errors.

According to an embodiment of the present disclosure, diagnosing the cause of the increase in exhaust gas may include an operation of determining an error rate for each of the at least two or more factors, wherein the error rate is a value obtained by dividing the accumulated and averaged reconstruction error by a preset reference value; and diagnosing the cause of the increase in exhaust gas, based on the error rate.

According to an embodiment of the present disclosure, the preset reference value may be an average value of the reconstruction error obtained in a normal driving state in which an exhaust gas is lower than or equal to a preset value for each of the at least two or more factors.

According to an embodiment of the present disclosure, the method may further include an operation of determining whether a measured NOx concentration value exceeds a preset value, and wherein diagnosing the cause of the increase in exhaust gas may be performed when the measured NOx concentration value exceeds the preset value, or when the measured NOx concentration value exceeds the preset value and a warning light is turned on.

According to an embodiment of the present disclosure, the factor may include a fuel pressure, a rear lambda voltage, a lambda control factor, a variable valve timing (VVT) incam error, a variable valve timing (VVT) excam error, a long term fuel trim (LTFT), an engine roughness sum, an engine gas recirculation (EGR) flow error, or a variable geometry turbocharger (VGT) value error.

According to an embodiment of the present disclosure, diagnosing the cause of the increase in exhaust gas may further include diagnosing, as the cause of the increase in exhaust gas, a fuel system when an error rate of the fuel pressure is greater than a preset error rate, a rear oxygen sensor when an error rate of the rear lambda voltage is greater than the preset error rate, a front oxygen sensor when an error rate of the lambda control factor is greater than the preset error rate, an intake VVT when an error rate of the VVT incam error is greater than the preset error rate, an exhaust VVT when an error rate of the VVT excam error is greater than the preset error rate, an air-fuel ratio when an error rate of the long term fuel trim is greater than the preset error rate, a misfire when an error rate of the engine roughness sum is greater than the preset error rate, an EGR when an error rate of the EGR flow error is greater than the preset error rate, and a VGT when an error rate of the VGT valve error is greater than the preset error rate.

According to an aspect of the present disclosure, a vehicle including an apparatus for diagnosing a cause of an increase in exhaust gas using an autoencoder. The apparatus includes at least one processor; and a storage medium storing a computer-readable instruction, wherein when the computer-readable instruction is executed by the at least one processor, the computer readable instruction is configured to cause the at least one processor to: receive input data, wherein the input data includes at least two or more factors including a sensed value; determine a reconstruction error for each of the at least two or more factors, wherein the reconstruction error is a reconstruction error between the input data and restored data obtained by inputting the input data to a pre-learned autoencoder; and diagnose the cause of the increase in exhaust gas, based on each of the reconstruction errors.

### BRIEF DESCRIPTION OF DRAWINGS

The above and other aspects, features, and advantages of the present disclosure are more clearly understood from the following detailed description, taken in conjunction with the accompanying drawings.

FIG. 1 is a view illustrating a vehicle including an apparatus for diagnosing a cause of an increase in exhaust gas using an autoencoder according to an embodiment of the present disclosure.

FIG. 2 is a view illustrating an autoencoder according to an embodiment of the present disclosure.

FIG. 3 is a flowchart illustrating a method for diagnosing a cause of an increase in exhaust gas using an autoencoder according to an embodiment of the present disclosure.

FIG. 4 is a block diagram of a computing device that may fully or partially implement an apparatus for diagnosing a cause of an increase in exhaust gas using an autoencoder according to an embodiment of the present disclosure.

### DETAILED DESCRIPTION

Hereinafter, specific embodiments of the present disclosure are described with reference to the accompanying drawings. The following detailed description is provided to aid in a comprehensive understanding of a method, a device and/or a system described in the present specification. However, the detailed description is for illustrative purposes only, and the present disclosure is not limited thereto.

In describing embodiments of the present disclosure, when it is determined that a detailed description of a known technology related to the present disclosure may unnecessarily obscure the gist of the present disclosure, a detailed description thereof has been omitted. In addition, terms to be described below are terms defined in consideration of functions in the present disclosure, which may be changed depending on intention or custom of a user or operator. Therefore, the definition of these terms should be made based on the contents throughout the present specification. The terminology used herein is for the purpose of describing particular embodiments only and is not to be limiting of the embodiments. As used herein, the singular forms are intended to include the plural forms as well, unless the context clearly indicates otherwise. As used herein, the terms “comprise,” “include,” “have,” or the like, when used in this specification, specify the presence of stated features, integers, steps, operations, elements, components or a combination thereof, but do not preclude the presence or addition of one or more other features, integers, steps, operations, elements, components, and/or groups thereof.

When a component, unit, device, element, apparatus, or the like of the present disclosure is described as having a purpose or performing an operation, function, or the like, the component, unit, device, element, apparatus, or the like should be considered herein as being “configured to” meet that purpose or to perform that operation or function. Each component, unit, device, element, apparatus, and the like may separately embody or be included with a processor and a memory, such as a non-transitory computer readable media, as part of the apparatus. Further, the term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

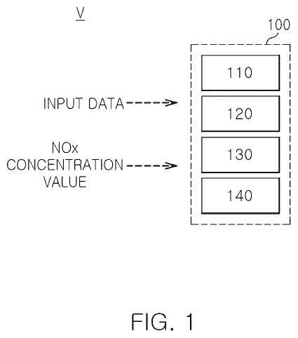

FIG. 1 is a view illustrating a vehicle including an apparatus for diagnosing a cause of an increase in exhaust gas using an autoencoder according to an embodiment of the present disclosure. A vehicle V may include an apparatus 100 for diagnosing a cause of an increase in exhaust gas, and the apparatus 100 may be implemented, for example, in an engine controller equipped in the vehicle V.

The apparatus 100 may include an input unit 110, a control unit 120, a storage unit 130, and an output unit 140.

First, the input unit 110 may receive input data and a NOx concentration value, and may transmit the received input data and the received NOx concentration value to the control unit 120. In this case, the input data may include at least two or more factors including a sensed value measured by various sensors, and engine status data. In addition, the NOx concentration value may be a concentration of NOx measured by a nitrogen oxide measurement sensor.

According to an embodiment of the present disclosure, the factors may include one or more of engine status data, a fuel pressure, a rear lambda voltage, a lambda control factor, a variable valve timing (VVT) incam error, a variable valve timing (VVT) excam error, a long term fuel trim (LTFT), an engine roughness sum, an engine gas recirculation (EGR) flow error, or a variable geometry turbocharger (VGT) value error.

In one example, the fuel pressure may be a pressure of a fuel, and the rear lambda voltage may refer to a voltage measured by an oxygen sensor mounted in an exhaust system of a vehicle. The lambda control factor may refer to an index used to adjust an air-fuel mixture ratio in an engine management system. The VVT incam error may refer to an intake camshaft (“incam”) for controlling opening and closing timing of a valve in a VVT system for adjusting valve timing according to operating conditions of an engine, and may refer to an error between a current value of VVT incam and a target value of VVT incam. The VVT excam error may refer to an exhaust camshaft (“excam”) for controlling timing of a camshaft in the VVT system for adjusting the valve timing according to the operating condition of the engine, and may refer to an error between a current value of VVT excam and a target value of VVT excam. In addition, the long term fuel trim may refer to a value for optimizing performance of the engine by adjusting a fuel mixture ratio. The engine roughness sum may refer to a condition in which the engine does not operate smoothly or vibrates. The EGR flow error may refer to a condition in which flow of an exhaust gas recirculation (EGR) system is outside of a normal range. The VGT valve error may refer to an error that occurs in a valve of a variable geometry turbocharger (VGT).

The engine status data may include one or more of a map sensor signal, an injection time, an engine revolution per minute (RPM) value, an engine load, a vehicle speed, a VVT incam angle, a VVT excam angle, a lambda controller output, a front lambda voltage, a lambda set value or a controller value. It should be noted that the engine status data only inputs, together with factors to the pre-learned autoencoder (described below), to obtain restoration data for each of the above-described factors, and that the reconstruction error is not calculated based on such engine status data.

In one example, the map sensor signal may refer to a signal from a map sensor. The injection time may refer to a length of time that fuel injection may be performed in a fuel injection system. The engine RPM may refer to a rotation speed of the engine. The engine load may refer to an indicator of how much work the engine may be currently doing. The VVT incam angle may refer to an angle of the incam in the VVT system, and the VT excam angle may refer to an angle of the excam in the VVT system. The lambda controller output may refer to a signal generated by a lambda controller based on data of a lambda sensor (oxygen sensor) to optimize the fuel-air mixture ratio of the engine. The front lambda voltage may refer to an electrical signal generated from the front oxygen sensor (lambda sensor) of the engine of the vehicle. The lambda set value may refer to a reference value for adjusting the fuel-air mixture ratio in an engine control system, and the controller value may refer to a value output from a controller of the engine control system.

Thereafter, the control unit 120 may determine (e.g., calculate) a reconstruction error for each of at least two or more factors, and may diagnose a cause of an increase in exhaust gas, based on the reconstruction error.

In one example, the reconstruction error may be a reconstruction error between input data and restored data obtained by inputting the input data into a pre-learned autoencoder. This reconstruction error may be accumulated and averaged (i.e., across each of at least two or more factors). The control unit 120 may be at least one processor (e.g., a computer, a microprocessor, a CPU, an ASIC, a logic circuit, and the like).

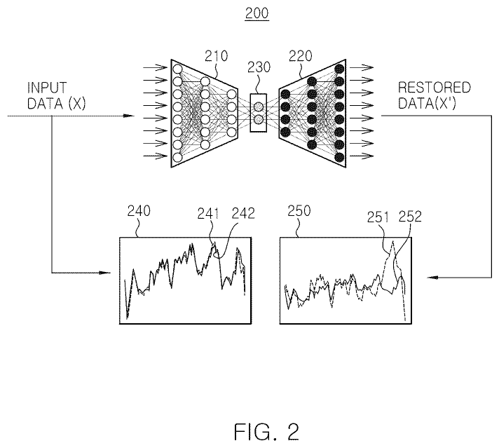

FIG. 2 is a view illustrating an autoencoder according to an embodiment of the present disclosure.

An autoencoder may be a type of artificial neural network used to learn efficient representation of data, and may be mainly used for purposes such as reducing a dimension of the data, removing noise, learning characteristics, detecting anomalies, or performing other functions.

Specifically, as illustrated in FIG. 2, an autoencoder 200 may be divided into an encoder (encode) 210 that compresses and converts input data X into a latent space 230, and a decoder (decode) 220 that restores the latent space 230 back to an original form thereof, to generate restored data X'.

When the autoencoder 200 is used, in a case of normal data, a reconstruction error 240 between input data 241 and restored data 242 may be small, while in a case of abnormal data, a reconstruction error 250 between input data 251 and restored data 252 may be large.

When a principle of the autoencoder 200 is used, after inputting input data related to an increase in exhaust gas into the autoencoder 200 to obtain restoration data, a cause of the increase in exhaust gas may be identified from a reconstruction error therebetween. It should be noted that in the present disclosure, the reconstruction error may be obtained for each factor included in the input data, not the entire input data.

The autoencoder 200 may be stored in advance in the storage unit 130 to be described below.

Hereinafter, a process of diagnosing the cause of the increase in exhaust gas, centered on the control unit 120, is described in detail.

Specifically, the control unit 120 may calculate an error rate for each of at least two or more factors, and then diagnose the cause of the increase in exhaust gas, based on the error rate.

In one example, the error rate may be a value obtained by dividing an accumulated and averaged reconstruction error by a preset reference value.

In addition, the preset reference value may be an average value of the reconstruction errors obtained in a normal driving state in which the exhaust gas is lower than or equal to a preset value for each of the at least two or more factors.

Specifically, the control unit 120 may diagnose, as the cause of the increase in exhaust gas, a fuel system when an error rate of the fuel pressure is greater than a preset error rate, a rear oxygen sensor when an error rate of the rear lambda voltage is greater than the preset error rate, a front oxygen sensor when an error rate of the lambda control factor is greater than the preset error rate, an intake VVT when an error rate of the VVT incam error is greater than the preset error rate, an exhaust VVT when an error rate of the VVT excam error is greater than the preset error rate, an air-fuel ratio when an error rate of the long term fuel trim is greater than the preset error rate, a misfire when an error rate of the engine roughness sum is greater than the preset error rate, an EGR when an error rate of the EGR flow error is greater than the preset error rate, and a VGT when an error rate of the VGT valve error is greater than the preset error rate. In one example, the preset error rate may have the same value for all errors, or may be different, depending on a type of error. In addition, it should be noted that the preset error rate may be appropriately set, depending on a need of those having ordinary skill in the art, and the present disclosure is not limited to a specific numerical value.

According to an embodiment of the present disclosure, when the air-fuel ratio is diagnosed as the cause of the increase in exhaust gas, the control unit 120 may diagnose the air-fuel ratio as a lean state when the air-fuel ratio is greater than 1, or may diagnose the air-fuel ratio as a rich state when the air-fuel ratio is less than 1.

In one example, the lean state in the air-fuel ratio may refer to a ratio between air and fuel in the engine in a state in which a relatively large amount of air and a relatively small amount of fuel are mixed, and the rich state in the air-fuel ratio may refer to a ratio between air and fuel in the engine in a state in which a relatively small amount of air and a relative large amount of fuel are mixed.

In addition, according to an embodiment of the present disclosure, the control unit 120 may determine whether a measured NOx concentration value exceeds a preset value, and may diagnose the cause of the increase in exhaust gas where the measured NOx concentration value exceeds the preset value, or where the measured NOx concentration value exceeds the preset value and a warning light is turned on.

In addition, according to an embodiment of the present disclosure, the control unit 120 may determine whether a stable driving condition is satisfied, and may operate only when the stable driving condition is satisfied.

In one example, the stable driving condition may include one or more of a vehicle speed (e.g., 0 kph or more), an engine RPM value (e.g., 600 or more and 3500 or less), a state in which a reverse gear is not engaged, an EGR ratio (e.g., more than 1%), a state in which a lambda control factor is not 1, a state in which learning of an on-board diagnostics (OBD) item is completed, an atmospheric pressure (e.g., more than 750 hPa), or a state in which a driving mode of a vehicle is not a sports mode.

Finally, the control unit 120 may control the output unit 140 to output the cause of the increase in exhaust gas.

According to an embodiment of the present disclosure, the control unit 120 may output a cause of an increase related to a factor in magnitude order of an error rate, for each of the at least two or more factors.

Alternatively, according to an embodiment of the present disclosure, the control unit 120 may output a cause of an increase related to a factor of a preset number (for example, 2) of which a magnitude of an error rate is large (i.e., satisfies a predetermined threshold), among the at least two or more factors, in magnitude order of an error rate.

The storage unit 130 is configured to store various programs and various data for implementing a function of the control unit 120 described above, and in particular, the autoencoder that has been learned, as described above, may be stored in advance in the storage unit 130.

Finally, the output unit 140 may output the cause of the increase in exhaust gas, or may turn on a warning light according to the control of the control unit 120.

As described above, according to an embodiment of the present disclosure, by diagnosing a cause of an increase in exhaust gas, based on a reconstruction error between input data and restored data, using an autoencoder, it is possible to confirm which component, system, or the like is the cause of the increase in exhaust gas, when monitoring the exhaust gas in accordance with the EURO7 standards introduced in Europe.

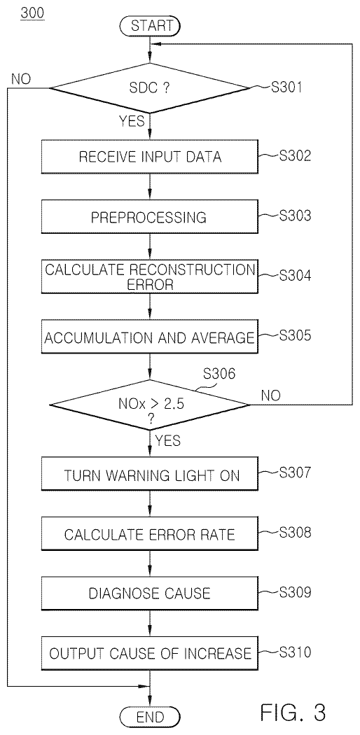

FIG. 3 is a flowchart illustrating a method for diagnosing a cause of an increase in exhaust gas using an autoencoder according to an embodiment of the present disclosure.

Hereinafter, with reference to FIGS. 1-3, a method for diagnosing a cause of an increase in exhaust gas using an autoencoder (S300), according to an embodiment of the present disclosure, is described. However, for simplification of the present disclosure, descriptions overlapping FIGS. 1 and 2 have been omitted.

Referring to FIGS. 1-3, a method for diagnosing a cause of an increase in exhaust gas using an autoencoder (S300), according to an embodiment of the present disclosure, may be started by determining whether a stable driving condition (SDC) is satisfied in an apparatus 100 for diagnosing a cause of an increase in exhaust gas (S301).

In one example, the stable driving conditions may include one or more of a vehicle speed (e.g., 0 kph or more), an engine RPM value (e.g., 600 or more and 3500 or less), a state in which a reverse gear is not engaged, an EGR ratio (e.g., more than 1%), a state in which a lambda control factor is not 1, a state in which learning of an on-board diagnostics (OBD) item is completed, an atmospheric pressure (e.g., more than 750 hPa), or a state in which a driving mode of a vehicle is not a sports mode, as described above.

When the stable driving conditions is satisfied as a determination result from S301, the apparatus 100 may receive input data (S302).

In one example, the input data may include at least two or more factors including sensing values measured by various sensors, and engine status data.

According to an embodiment of the present disclosure, as described above, the factors may include one or more of engine status data, a fuel pressure, a rear lambda voltage, a lambda control factor, a variable valve timing (VVT) incam error, a variable valve timing (VVT) excam error, a long term fuel trim (LTFT), an engine roughness sum, an engine gas recirculation (EGR) flow error, or a variable geometry turbocharger (VGT) value error.

As described above, the engine status data may include one or more of a map sensor signal, an injection time, an engine revolution per minute (RPM) value, an engine load, a vehicle speed, a VVT incam angle, a VVT excam angle, a lambda controller output, a front lambda voltage, a lambda set value or a controller value.

The apparatus 100 may perform preprocessing on the input data (S303). For example, a standard scaler or the like may be used for the preprocessing, but is not necessarily limited thereto.

Thereafter, the apparatus 100 may calculate a reconstruction error for each of the at least two or more factors (S304).

In one example, as described above, the reconstruction error may be a reconstruction error between the input data and restored data obtained by inputting the input data to a pre-learned autoencoder.

Thereafter, the apparatus 100 may accumulate and average the reconstruction errors (i.e., for each of the at least two or more factors) (S305).

The apparatus 100 may determine whether a NOx concentration value exceeds a preset value (e.g., 2.5) (S306).

As a determination result from S306, when the NOx concentration value exceeds the preset value (e.g., 2.5), the apparatus 100 may turn on a warning light (S307).

Thereafter, the apparatus 100 may calculate an error rate for each of the at least two or more factors, (S308) and may diagnose the cause of the increase in exhaust gas, based on the error rate (S309). In one example, the error rate may be a value obtained by dividing the accumulated and averaged reconstruction error by a preset reference value. In addition, as described above, the preset reference value may be an average value of the reconstruction error obtained in a normal driving state in which the exhaust gas is lower than or equal to a preset value for each of the at least two or more factors.

Specifically, the apparatus 100 may diagnose, as the cause of the increase in exhaust gas, a fuel system when an error rate of the fuel pressure is greater than a preset error rate, a rear oxygen sensor when an error rate of the rear lambda voltage is greater than the preset error rate, a front oxygen sensor when an error rate of the lambda control factor is greater than the preset error rate, an intake VVT when an error rate of the VVT incam error is greater than the preset error rate, an exhaust VVT when an error rate of the VVT excam error is greater than the preset error rate, an air-fuel ratio when an error rate of the long term fuel trim is greater than the preset error rate, a misfire when an error rate of the engine roughness sum is greater than the preset error rate, an EGR when an error rate of the EGR flow error is greater than the preset error rate, or a VGT when an error rate of the VGT valve error is greater than the preset error rate. In one example, as described above, the preset error rate may be appropriately set, depending on a need of those having ordinary skill in the art.

In addition, when the air-fuel ratio is diagnosed as the cause of the increase in exhaust gas, the apparatus 100 may diagnose the air-fuel ratio as a lean state when the air-fuel ratio is greater than 1, or may diagnose the air-fuel ratio as a rich state when the air-fuel ratio is less than 1, as described above.

Finally, the apparatus 100 may output the cause of the increase in exhaust gas (S310), as described above.

According to an embodiment of the present disclosure, the apparatus 100 may output a cause of an increase related to a factor in magnitude order of an error rate, for each of the at least two or more factors.

Alternatively, according to an embodiment of the present disclosure, the apparatus 100 may output a cause of an increase related to a factor of a preset number (for example, 2) of which a magnitude of an error rate is large (i.e., meets or exceeds a threshold), among the at least two or more factors, in magnitude order of an error rate, as described above.

As described above, according to an embodiment of the present disclosure, by diagnosing a cause of an increase in exhaust gas, based on a reconstruction error between input data and restored data, using an autoencoder, it is possible to confirm which component, system, or the like is the cause of the increase in exhaust gas, when monitoring the exhaust gas in accordance with the EURO7 standards introduced in Europe.

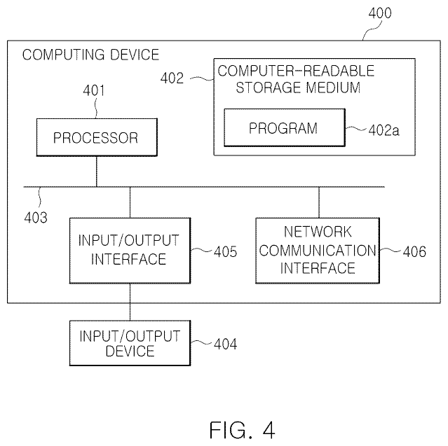

FIG. 4 is a block diagram of a computing device that may fully or partially implement an apparatus 100 for diagnosing a cause of an increase in exhaust gas using an autoencoder according to an embodiment of the present disclosure.

As illustrated in FIG. 4, a computing device 400 may include at least one processor 401, computer-readable storage medium 402, and a communication bus 403.

The processor 401 may enable the computing device 400 to operate according to the above-mentioned embodiments. For example, the processor 401 may execute one or more programs stored in the computer-readable storage medium 402. The one or more programs may include one or more computer-executable instructions, which, when executed by the processor 401, cause the computing device 400 to perform operations according to the embodiments described above.

The computer-readable storage medium 402 may be configured to store a computer-executable instruction or program code, program data, and/or information having other suitable form. A program 402a stored in the computer-readable storage medium 402 may include a set of instructions executable by the processor 401. In an embodiment, the computer-readable storage medium 402 may include a memory (a volatile memory, such as a random access memory, a non-volatile memory, or an appropriate combination thereof), at least one magnetic disk storage device, at least one optical disk storage device, at least one flash memory device, a storage medium accessible by the computing device 400 and storing desired information, or a suitable combination thereof.

The communication bus 403 may be interconnected with various components of the computing device 400 which includes the processor 401, the computer-readable storage medium 402, and the like.

The computing device 400 may also include at least one input/output interface 405 and at least one network communication interface 406, providing an interface for at least one input/output device 404. The input/output interface 405 and the network communication interface 406 may be connected to the communication bus 403. The network may be any one of a cellular network, such as global system for mobile communications (GSM), enhanced data rates for GSM evolution (EDGE), general packet radio service (GPRS), code division multiple access (CDMA), time division-CDMA (TD-CDMA), universal mobile telecommunications system (UMTS), long term evolution (LTE), or another cellular network. Additionally, the network communication interface 406 may further include one of wireless tag technologies, such as Near Field Communication (NFC).

The input/output device 404 may be coupled to other components of the computing device 400 through the input/output interface 405. An input/output device 404 may include, but is not limited to, an input device such as a pointing device (such as a mouse, a trackpad, or the like), a keyboard, a touch input device (such as a touchpad, a touch screen, or the like), a voice or sound input device, various types of sensor devices, and/or various types of imaging devices, and/or an output device such as a display device, a printer, a speaker, and/or a network card. The example input/output device 404 may be included in the computing device 400 as a component constituting the computing device 400, or may be connected to the computing device 400 as a separate device distinct from the computing device 400.

An embodiment of the present disclosure may include a program for performing methods described in the present specification on a computer, and a computer-readable recording medium containing the program. The computer-readable recording medium may include a program instruction, a local data file, a local data structure, or the like, singly or in combination. The medium may be those specifically designed and constructed for the present disclosure, or may be those commonly available in a computer software field. Examples of computer-readable recording medium may include a magnetic medium such as a hard disk, a floppy disk, or a magnetic tape, an optical recording medium such as a CD-ROM or a DVD, and a hardware device specifically configured to store and perform a program instruction such as a ROM, a RAM, a flash memory, or the like. Examples of the program may include not only a machine language code such as that generated by a compiler, but also a high-level language code that may be executed by a computer using an interpreter or the like.

According to an embodiment of the present disclosure, by diagnosing a cause of an increase in exhaust gas, based on a reconstruction error between input data and restored data, using an autoencoder, it is possible to confirm which component, system, or the like is the cause of the increase in exhaust gas, when monitoring the exhaust gas in accordance with the EURO7 standards introduced in Europe.

While example embodiments have been illustrated and described above, it should be apparent to those having ordinary skill in the art that modifications and variations could be made without departing from the scope of the present disclosure as defined by the appended claims.

What is claimed is:

1. An apparatus for diagnosing a cause of an increase in exhaust gas using an autoencoder, the apparatus comprising:
at least one processor; and
a storage medium configured to store a computer-readable instruction,
wherein when the computer-readable instruction is executed by the at least one processor, the computer-readable instruction is configured to cause the at least one processor to:
receive input data, wherein the input data includes at least two or more factors including a sensed value;
determine a reconstruction error for each of the at least two or more factors, wherein the reconstruction error is a reconstruction error between the input data and restored data obtained by inputting the input data to a pre-learned autoencoder; and
diagnose the cause of the increase in exhaust gas, based on each of the reconstruction errors.

2. The apparatus of claim 1, wherein the at least one processor is configured to accumulate and average the reconstruction errors to get an accumulated and averaged reconstruction error.

3. The apparatus of claim 2, wherein the at least one processor is further configured to:
determine an error rate for each of the at least two or more factors, wherein the error rate is a value obtained by dividing the accumulated and averaged reconstruction error by a preset reference value; and
diagnose the cause of the increase in exhaust gas, based on each of the error rates.

4. The apparatus of claim 3, wherein the preset reference value is an average value of the reconstruction errors obtained in a normal driving state in which an exhaust gas is lower than or equal to a preset value for each of the at least two or more factors.

5. The apparatus of claim 2, wherein the at least one processor is further configured to:
determine whether a measured nitrogen oxide (NOx) concentration value exceeds a preset value; and
diagnose the cause of the increase in exhaust gas when the measured NOx concentration value exceeds the preset value, or when the measured NOx concentration value exceeds the preset value and a warning light is turned on.

6. The apparatus of claim 1, wherein the at least one processor is configured to determine whether a stable driving condition is satisfied, and
wherein the stable driving condition includes one or more of a vehicle speed, an engine revolutions per minute(RPM)value, a state in which a reverse gear is not engaged, an exhaust gas recirculation (EGR) ratio, a state in which a lambda control factor is not 1, a state in which learning of an on-board diagnostics (OBD) item is completed, an atmospheric pressure, or a state in which a driving mode of a vehicle is not a sports mode.

7. The apparatus of claim 3, wherein the at least two or more factors comprises one or more of a fuel pressure, a rear lambda voltage, a lambda control factor, a variable valve timing (VVT) incam error, a VVT excam error, a long term fuel trim (LTFT), an engine roughness sum, an engine gas recirculation (EGR) flow error, or a variable geometry turbocharger (VGT) value error.

8. The apparatus of claim 7, wherein the at least one processor is further configured to diagnose, as the cause of the increase in exhaust gas:
a fuel system when an error rate of the fuel pressure is greater than a preset error rate,
a rear oxygen sensor when an error rate of the rear lambda voltage is greater than the preset error rate,
a front oxygen sensor when an error rate of the lambda control factor is greater than the preset error rate,
an intake VVT when an error rate of the VVT incam error is greater than the preset error rate,
an exhaust VVT when an error rate of the VVT excam error is greater than the preset error rate,
an air-fuel ratio when an error rate of the long term fuel trim is greater than the preset error rate,
a misfire when an error rate of the engine roughness sum is greater than the preset error rate,
an EGR when an error rate of the EGR flow error is greater than the preset error rate, and
a VGT when an error rate of the VGT valve error is greater than the preset error rate.

9. The apparatus of claim 8, wherein, when the air-fuel ratio is diagnosed as the cause of the increase in exhaust gas, the at least one processor is configured to diagnose the air-fuel ratio as a lean state when the air-fuel ratio is greater than 1, or diagnose the air-fuel ratio as a rich state when the air-fuel ratio is less than 1.

10. The apparatus of claim 1, wherein the input data further comprises engine status data, and
wherein the engine status data includes one or more of a map sensor signal, an injection time, an engine revolution per minute (RPM) value, an engine load, a vehicle speed, a variable valve timing (VVT) incam angle, a VVT excam angle, a lambda controller output, a front lambda voltage, a lambda set value or a controller value.

11. The apparatus of claim 3, wherein the at least one processor is further configured to output the cause of the increase in exhaust gas.

12. The apparatus of claim 3, wherein the at least one processor is further configured to:
output a cause of an increase related to a factor in magnitude order of an error rate, for each of the at least two or more factors, or
output a cause of an increase related to a factor of a preset number of which a magnitude of an error rate satisfies a threshold, among the at least two or more factors, in magnitude order of an error rate.

13. A method for diagnosing a cause of an increase in exhaust gas using an autoencoder, the method comprising:
receiving input data, wherein the input data includes at least two or more factors including a sensed value;
determining a reconstruction error for each of the at least two or more factors, wherein the reconstruction error is a reconstruction error between the input data and restored data obtained by inputting the input data to a pre-learned autoencoder; and
diagnosing the cause of the increase in exhaust gas, based on each of the reconstruction errors.

14. The method of claim 13, further comprising accumulating and averaging the reconstruction errors to get an accumulated and averaged reconstruction error.

15. The method of claim 14, wherein diagnosing the cause of the increase in exhaust gas comprises:
determining an error rate for each of the at least two or more factors, wherein the error rate is a value obtained by dividing the accumulated and averaged reconstruction error by a preset reference value; and
diagnosing the cause of the increase in exhaust gas, based on each of the error rates.

16. The method of claim 15, wherein the preset reference value is an average value of the reconstruction errors obtained in a normal driving state in which an exhaust gas is lower than or equal to a preset value for each of the at least two or more factors.

17. The method of claim 14, further comprising determining whether a measured nitrogen oxide (NOx) concentration value exceeds a preset value, and
wherein diagnosing the cause of the increase in exhaust gas is performed when the measured NOx concentration value exceeds the preset value, or when the measured NOx concentration value exceeds the preset value and a warning light is turned on.

18. The method of claim 15, wherein the at least two or more factors comprises one or more of a fuel pressure, a rear lambda voltage, a lambda control factor, a variable valve timing (VVT) incam error, a VVT excam error, a long term fuel trim (LTFT), an engine roughness sum, an engine gas recirculation (EGR) flow error, or a variable geometry turbocharger (VGT) value error.

19. The method of claim 18, wherein diagnosing the cause of the increase in exhaust gas further comprises diagnosing, as the cause of the increase in exhaust gas:
a fuel system when an error rate of the fuel pressure is greater than a preset error rate,
a rear oxygen sensor when an error rate of the rear lambda voltage is greater than the preset error rate,
a front oxygen sensor when an error rate of the lambda control factor is greater than the preset error rate,
an intake VVT when an error rate of the VVT incam error is greater than the preset error rate,
an exhaust VVT when an error rate of the VVT excam error is greater than the preset error rate,
an air-fuel ratio when an error rate of the long term fuel trim is greater than the preset error rate,
a misfire when an error rate of the engine roughness sum is greater than the preset error rate,
an EGR when an error rate of the EGR flow error is greater than the preset error rate, and
a VGT when an error rate of the VGT valve error is greater than the preset error rate.

20. A vehicle including an apparatus for diagnosing a cause of an increase in exhaust gas using an autoencoder, wherein the apparatus comprises:
at least one processor; and
a storage medium configured to store a computer-readable instruction,
wherein when the computer-readable instruction is executed by the at least one processor, the computer readable instruction is configured to cause the at least one processor to:
receive input data, wherein the input data includes at least two or more factors including a sensed value;
determine a reconstruction error for each of the at least two or more factors, wherein the reconstruction error is a reconstruction error between the input data and restored data obtained by inputting the input data to a pre-learned autoencoder; and
diagnose the cause of the increase in exhaust gas, based on each of the reconstruction errors.
